(19) United States
(12) Patent Application Publication
(10) Pub. No.: US 2021/0144275 A1
(43) Pub. Date: May 13, 2021

(54) IMAGE PROCESSING APPARATUS AND IMAGE PROCESSING METHOD CAPABLE OF LIMITING CONTENT OF DOCUMENT DISPLAYED ON PREVIEW SCREEN

(71) Applicant: KYOCERA Document Solutions Inc., Osaka (JP)

(72) Inventors: Shigenaka KANEMITSU, Osaka (JP); Isaac JUDD, Nara (JP); Kiyoshi HORI, Kobe (JP); Tetsuya YOSHIOKA, Osaka (JP); Keisaku MATSUMAE, Osaka (JP); Toshinobu YOSHIDA, Osaka (JP); Keisuke FUKUSHIMA, Osaka (JP)

(73) Assignee: KYOCERA Document Solutions Inc., Osaka (JP)

(21) Appl. No.: 17/092,280

(22) Filed: Nov. 8, 2020

(30) Foreign Application Priority Data
Nov. 8, 2019 (JP) 2019-203354

(51) Int. Cl. H04N 1/44; H04N 1/00

(52) U.S. Cl. CPC H04N 1/4493; H04N 1/00442; H04N 1/444

(57) ABSTRACT

Provided are an image processing apparatus and an image processing method capable of limiting the content of a document displayed on a preview screen. The image processing apparatus and image processing method according to this disclosure generate limited display data for displaying a limited document in which the content of a limited area satisfying a specific limiting condition cannot be recognized in a document indicated by document data of a processing target in the image processing apparatus. Then display the preview screen of the limited document on a display unit of the image processing apparatus based on the limited display data.

### INCORPORATION BY REFERENCE

This application is based on and claims the benefit of priority from Japanese Patent Application No. 2019-203354 filed on Nov. 8, 2019, the contents of which are hereby incorporated by reference.

### BACKGROUND

The present disclosure relates to an image processing apparatus and an image processing method.

Generally, an image processing apparatus capable of displaying the contents of a document on a preview screen based on the document data read from the document.

### SUMMARY

The image processing apparatus according to an aspect of the present disclosure includes a generation processing unit and a display processing unit. The generation processing unit generates limited display data for displaying a limited document in which content of a limited area satisfying a specific limiting condition cannot be recognized in a document indicated by document data of a processing target in the image processing apparatus. The display processing unit displays a preview screen of the limited document on a display unit of the image processing apparatus based on the limited display data.

The image processing method according to an aspect of the present disclosure includes a generation step and a display step. The generation step generates limited display data for displaying a limited document in which content of a limited area satisfying a specific limiting condition cannot be recognized in a document indicated by document data of a processing target in an image processing apparatus. The display step displays a preview screen of the limited document on the display unit of the image processing apparatus based on the limited display data.

### BRIEF DESCRIPTION OF THE DRAWINGS

FIG. 1 is a block diagram illustrating a system configuration of an image processing apparatus of an embodiment according to the present disclosure.

FIG. 2 is a diagram illustrating the appearance of an operation display unit of an image processing apparatus of an embodiment according to the present disclosure.

FIG. 3 is a flowchart illustrating an example of a procedure of a preview process executed by an image processing apparatus of an embodiment according to the present disclosure.

FIG. 4 is a diagram illustrating an example of document data used in an image processing apparatus of an embodiment according to the present disclosure.

FIG. 5 is a diagram illustrating an example of limited display data used in an image processing apparatus of an embodiment according to the present disclosure.

FIG. 6 is a diagram illustrating an example of preview screen used in an image processing apparatus of an embodiment according to the present disclosure.

### DETAILED DESCRIPTION

Hereinafter, embodiments according to the present disclosure will be described with reference to the accompanying drawings to help understand the present disclosure. Note that the following embodiments are examples that embody the technique according to the present disclosure, and do not limit the technical scope of the present disclosure.

### [Configuration of an Image Processing Apparatus]

As illustrated in FIG. 1, an image processing apparatus 1 of an embodiment according to the present disclosure includes an operation display unit 10, an ADF (Auto Document Feeder) 11, an image reading unit 12, an image forming unit 13, a communication I/F 14, a storage unit 15 and a control unit 16. More specifically, the image processing apparatus 1 is a multifunction apparatus having a printer function, a scanner function, a copy function, a facsimile function, and the like. Note that the technique of the present disclosure is not limited to multifunction apparatuses, and may be applied to any image processing apparatus such as a scanner, a copier, a printer, and a facsimile apparatus.

As illustrated in FIG. 2, the operation display unit 10 includes a display unit 20 such as a liquid crystal display or the like that displays information, and an operation unit such as a touch panel 21 or the like that receives user operations. The touch panel 21 is provided on a screen of the display unit 20 and can detect a touch operation on the display unit 20.

For example, the display unit 20 displays various display screens such as a preview screen P1 or the like for displaying a document indicated by document data. Moreover, one or a plurality of soft keys is displayed on the display unit 20 as needed. In FIG. 2, the operation key K1 for changing the display position of a document is displayed as a soft key in the preview screen P1. In addition, on the display unit 20, an operation key K2 for starting user authentication, an operation key K3 for closing the preview screen P1, and the like are also displayed as soft keys. Note that the operation display unit 10 may be provided with hard keys for receiving user operations.

The ADF 11 is an automatic document conveying apparatus that includes a document setting unit, a conveying roller, a document holder, and a paper ejection unit, and conveys a document to be reading target by an image reading unit 12.

The image reading unit 12 includes a document placement glass, a light source, a mirror, an optical lens, and a CCD (Charge Coupled Device), and is able to read an image of a document and output it as document data.

The image forming unit 13 is able to execute a printing process based on document data by an electrophotographic method or an inkjet method, and forms an image on a sheet based on the document data. For example, in a case where the image forming unit 13 is an image forming unit of the electrophotographic method, the image forming unit 13 includes a photosensitive drum, a charging device, an exposing device, a developing device, a transferring device, a fixing device, and the like.

The communication I/F 14 is a communication interface that is able to execute a communication process according to a specific communication protocol with an external facsimile apparatus or an information processing apparatus such as a personal computer or the like via a communication network such as a telephone line, the Internet, an LAN or the like.

The storage unit 15 is a non-volatile storage unit such as a hard disk, EEPROM (registered trademark), or the like. More specifically, the storage unit 15 stores an image processing program for causing a computer such as the control unit 16 to execute a preview process as will be described later. In addition, the storage unit 15 stores document data and the like to be processed by the image processing apparatus 1.

The control unit 16 includes control devices such as a CPU, ROM, RAM and the like. The CPU is a processor that executes various arithmetic processes. The ROM is a non-volatile storage unit in which information such as a control program or the like for causing the CPU to execute various processes is stored in advance. The RAM is a volatile or non-volatile storage unit that is used as a temporary storage memory (work area) for various processes that are executed by the CPU.

In addition, the control unit 16 includes a generation processing unit 161, an authentication processing unit 162, a display processing unit 163, and the like. Note that the control unit 16 functions as each of these processing units by executing various processes according to the image processing program. Furthermore, the control unit 16 may also include one or a plurality of electronic circuits for achieving a part of or all of the processing functions of each of these processing units.

The generation processing unit 161 generates limited display data for displaying a limited document in which the content of a limited area satisfying a specific limiting condition cannot be recognized in a document indicated by document data of a processing target in the image processing apparatus 1. More specifically, in the present embodiment, the specific limiting condition is an area including characters or an area including figures. Note that, as another embodiment, it is possible to define only one of an area including characters and an area including figures as the specific limiting condition.

The generation processing unit 161 generates the limited display data by performing a specific imaging process such as a scrambling process, a mask process, a mosaic process or the like on the limited area in the document indicated by the document data. For example, the scrambling process is a process in which, by executing a diffusion process for each fixed quantization unit on an image corresponding to the limited area, the content of the image in the limited area becomes unrecognizable state to the content when viewed by the human eye. Further, the mask process is a process in which, by filling the limited area with a preset noise pattern or a single color pattern so that the content of the image in the limited area becomes unrecognizable state when viewed by the human eye. Note that the method for generating the limited display data in which the limited area is unrecognizable is not limited to a scrambling process, a mask process, a mosaic process, or the like, and may be some other imaging process.

The authentication processing unit 162 executes an authentication process for authenticating the user. For example, the authentication processing unit 162 authenticates the user according to an ID and password input operation by the user. In addition, the authentication processing unit 162 may authenticate the user based on a reading result by a reader that reads information from a card or a mobile terminal owned by the user. Note that the authentication method by the authentication processing unit 162 is not limited to these methods.

Furthermore, in the image processing apparatus 1, the presence or absence of a preset specific authority may be set for each user, and the control unit 16 is able to control the presence or absence of usage restrictions of the image processing apparatus 1 depending on the type of user authenticated by the authentication processing unit 162. For example, as will be described later, the control unit 16 allows the display of the preview screen of a document based on the document data in a case where the user having specific authority is authenticated by the authentication processing unit 162. In addition, in a case where the user with specific authority is not authenticated, the control unit 16 limits the display of the preview screen of a document based on the document data.

The display processing unit 163 causes the operation display unit 10 of the image processing apparatus 1 to display the preview screen P1 (see FIG. 6) of the limited document based on the limited display data generated by the generation processing unit 161. In addition, the display processing unit 163 is also able to display the preview screen P1 (see FIG. 2) of the document based on the document data when the user having specific authority is authenticated by the authentication processing unit 162.

In addition, the control unit 16 is also able to execute a scanning process or the like in which the image reading unit 12 reads an image from a plurality of documents set in the ADF 11 and outputs the document data read from the documents to the storage unit 15 or to the outside. Moreover, the control unit 16 is able to execute a printing process of printing document data inputted from the outside or document data stored in the storage unit 15 on a sheet by the image forming unit 13. Furthermore, the control unit 16 is able to execute a copying process of reading the image of a document set at the image reading unit 12 and printing the read document data on a sheet by the image forming unit 13. Note that the control unit 16 is also able to execute a facsimile process for transmitting or receiving document data via a telephone line or the like.

In addition, the control unit 16 also includes a preview display function that causes the operation display unit 10 to display contents of document data of a processing target on a preview screen when executing these various jobs such as the printing process, the scanning process, the copying process, the facsimile process, and the like. Incidentally, there are situations in which it is not preferable to display the contents of a document on a preview screen. For example, when the content of a highly confidential document is displayed on a preview screen, the confidentiality of the document is impaired. On the other hand, in the image processing apparatus 1 of an embodiment according to the present disclosure, the content of the document displayed on the preview screen can be limited.

### [Preview Process]

Hereinafter, an example of the procedure of the preview process executed by the control unit 16 will be described with reference to FIG. 3. Here, steps S1, S2, and the like, represent the number of the processing procedure (step) executed by the control unit 16. The present disclosure may be regarded as a disclosure of an image processing method in which a preview process is executed by the control unit 16, or an image processing program for causing the control unit 16 to execute the image processing method.

### <Step S1>

In step S1, the control unit 16 determines whether or not the preview display operation has been performed on the operation display unit 10. Then, when it is determined that the preview display operation has been performed (S1: YES), the process proceeds to step S3, and when it is determined that the preview display operation has not been performed (S1: NO), the process proceeds to step S2.

For example, in a case where the user performs a preview display operation on the operation display unit 10 at any timing before, during, or after the execution of the various jobs in the image processing apparatus 1, the control unit 16 determines that the preview display operation has been performed. This is determined after the user performs an operation of arbitrarily selecting the document data of the processing target using the operation display unit 10, or in a state where the document data of the processing target is automatically selected. Hereinafter, the document data of the processing target may be referred to as the target document data D1.

### <Step S2>

In step S2, the control unit 16 determines whether or not to automatically execute the preview display of the target document data without any user operation. Then, when it is determined to automatically execute the preview display (S2: YES), the process proceeds to step S3, and when it is determined not to automatically execute the preview display (S2: NO), the process returns to step S1.

For example, in a case where when a preset specific abnormality occurs while the image processing apparatus 1 is executing a job, the control unit 16 determines to execute a preview display of the target document data to be the processing target by the job. The specific abnormality is an error or the like that occurs in a case where the document data is not read normally in the scanning process for reading the document data from the document. More specifically, in a case where the document data read from the document in the scanning process is detected to have a fold or is skewed, the control unit 16 determines that the specific abnormality has occurred and selects that document data as the target document data. Note that in a case where the specific abnormality occurs, the job being executed is interrupted, and the job is restarted after a recovery operation is performed by the user. Also note that it is not necessary that either step S1 or step S2 be executed.

### <Step S3>

In step S3, the control unit 16 specifies the character area included in the document indicated by the target document data D1 as a first limited area. A character area is an area that includes characters such as numbers, kana characters, kanji characters, alphabet characters, symbols, and the like, and the target document data D1 may include one or more character areas. In addition, the character area is an area such as a rectangular area, a polygon or the like that surrounds a series of character groups including a plurality of characters. Note that a character area may be specified by using a character recognition technique, or other conventionally known methods may be used.

### <Step S4>

In step S4, the control unit 16 specifies a figure area included in the document indicated by the target document data D1 as a second limited area. The figure area is an area that includes a figure such as a photograph, a table, a figure or the like, and the target document data D1 may include one or more figure areas. For example, in a case where the target document data D1 is binarized by a first threshold value and the size of the circumscribing rectangle of a black pixel region where the black pixels are continuous is equal to or larger than a preset second threshold value, the control unit 16 extracts the black pixel region as the figure region. Note that the figure area may be specified using a print rate, image density, or the like, or other conventionally known methods may be used. Moreover, steps S3 or S4 may be omitted, and in a case where step S3 is omitted, steps S5 to S6 that will be described later are also omitted.

More specifically, FIG. 4 is a diagram illustrating an example of target document data D1. In FIG. 4, in the target document data D1, the character area A11 that includes the character string of “abc . . . cde”, the character area A12 that includes the character string of “fgh . . . xyz”, and the character area A13 that includes the character “3” are each specified as first limited areas. Similarly, in the target document data D1, two figure areas A21, A22 that include photographs are each specified as the second limited areas.

### <Step S5>

In step S5, the control unit 16 determines whether or not a character area is included in the preset non-limited area of the target document data D1. The non-limited area is an area in which identification information for identifying the target document is described. For example, the non-limited area is a specific range preset as a position in the document indicated by the target document data D1 where the page number of the target document data D1 is described. Furthermore, the non-limited area is not limited to the page number, and may be an area in which other identification information is described.

### <Step S6>

In step S6, for the target document data D1 the control unit 16 excludes the character area in the non-limited area from the first limited area. In other words, the character area including the information for identifying the target document data D1 such as the page number is excluded from the first limited area. For example, in the target document data D1 illustrated in FIG. 4, of the three character areas A11, A12, and A13, the character area A13 existing in the non-limited area is excluded from the first limited area. Note that in addition, as another embodiment, steps S5 and S6 may be omitted.

### <Step S7>

In step S7, the control unit 16 generates limited display data D2 for displaying the limited document in which the contents of the first limited area and the second limited area are no recognizable among the documents indicated by the target document data D1. This is based on the target document data D1 and the first limited area and the second limited area. Step S7 is executed by the generation processing unit 161 of the control unit 16, and is an example of a generation step according to the present disclosure.

More specifically, the control unit 16 executes a specific imaging process that is specified in advance on the first limited area and the second limited area of the target document data D1. As described above, the specific imaging process includes the scrambling process, the mask process, the mosaic process, and the like. In particular, the control unit 16 executes different types of imaging processes such as the scrambling process, the mask process, the mosaic process or the like in the first limited area and the second limited area. This is so that the first limited area and the second limited area can be identifiable when the limited display data D2 is displayed.

Here, FIG. 5 is a diagram illustrating an example of the limited display data D2. As illustrated in FIG. 5, in the limited display data D2, the character areas A11, A12 and the figure areas A21, A22 included in the target document data D1 are processed by imaging processes such as the scrambling process, the mask process, the mosaic process, or the like.

In particular, in a state where there is a plurality of limited areas such as the first limited area and the second limited area, the control unit 16 generates limited display data D2 capable of displaying the plurality of limited areas in an identifiable manner. More specifically, the control unit 16 executes imaging processes having different contents for the first limited area and the second limited area so that when the limited document is displayed based on the limited display data D2, the first limited area and the second limited area can be distinguished from each other. For example, a case where the mask process is applied to the first limited area and the second limited area will be described. In this case, it is conceivable that the first limited area is masked with a fill image having a preset first color. Then, in this case, it is conceivable that the second limited area is masked with a fill image having a preset second color that is different from the first color. On the other hand, in the limited display data D2, the character area A13 in the non-limited area is excluded from the first limited area, so that the imaging process is not performed.

Note that as another embodiment, in a case where a plurality of first limited areas exist, imaging processes having different contents or different types of imaging processes may be executed in each of the first limited areas so that each of the first limited areas is identifiable. For example, it is conceivable that the color of the fill image used in the mask process is preset according to the order of the area or the order of position of the first limited area. Note that for the second limited areas as well, imaging processes having different contents or different types of imaging processes may be similarly executed for each of the second limited areas.

### <Step S8>

In step S8, the control unit 16 determines whether or not a user having specific authority has been authenticated in the image processing apparatus 1. More specifically, in a case where the authentication processing unit 162 has already executed authentication of a user having specific authority, and the user having specific authority is logged in to the image processing apparatus 1, the control unit 16 determines that authentication is completed. In step S8, when it is determined that authentication is completed (S8: YES), the process proceeds to step S91, and when it is determined that authentication is not completed (S8: NO), the process proceeds to step S81.

### <Step S81>

In step S81, the control unit 16 causes the operation display unit 10 to display a preview screen P1 (see FIG. 6) on which a limited document in which the contents of the first limited areas and the second limited areas are limited based on the limited display data D2 generated in step S7. Step S81 is executed by the display processing unit 163 of the control unit 16, and is an example of a display step according to the present disclosure.

Here, FIG. 6 is a diagram illustrating an example of a preview screen P1 when the limited document is displayed based on the limited display data D2. In the preview screen P1 illustrated in FIG. 6, the character areas A11, A12 and the figure areas A21, A22 specified as the first limited areas and the second limited areas are processed by imaging processes such as the scrambling process, the mask process, the mosaic process or the like. Therefore, by referring to the preview screen P1, the user is not able to recognize the content of the document corresponding to the target document data D1, but is able to grasp information such as the position where the first limited areas and the second limited areas exist, as well as the size and the like. Therefore, in a case where an abnormality occurs during the scanning process, for example, the user is able to easily grasp the content of the abnormality or to perform recovery work or the like for recovering from the abnormality.

In particular, as described above, in the target document data D1, imaging processes having different contents are executed in the first limited areas and the second limited areas, and on the preview screen P1, the display states of the first limited areas and the second limited areas are different. Therefore, the user is able to distinguish between the character areas specified as the first limited areas and the figure areas specified as the second limited areas. Note that in a case where the first limited areas and the second limited areas can be distinguished from each other, it is also possible to perform different types of imaging processes to the first limited areas and the second limited areas. For example, it is conceivable that a scrambling process is executed in the first limited areas and a mask process is executed in the second limited areas. Note that, as another embodiment, the same imaging process may be executed in all of the first limited areas and the second limited areas.

### <Step S9>

In step S9, the control unit 16 causes the operation display unit 10 to display a preview screen P1 on which a document is displayed in which the contents of the first limited areas and the second limited areas are not limited based on the target document data D1. Note that an example of a preview screen P1 when a document is displayed based on the target document data D1 is illustrated in FIG. 2.

As a result, a user who does not have specific authority cannot grasp the content of a document indicated by the target document data D1 even by referring to the preview screen P1. However, as a result, a user having specific authority is able to grasp the content of the document indicated by the target document data D1 by referring to the preview screen P1.

Note that step S8 is repeatedly executed even after the preview screen P1 is displayed in step S81 or S9 until the preview screen P1 is closed. Therefore, in a case where a user with specific authority is authenticated after the preview screen P1 is displayed, it is determined at that time that the user with specific authority is authenticated (S8: YES), and the process proceeds to step S9. For example, in a case where the operation key K2 displayed on the display unit 20 is operated, the control unit 16 causes a screen for inputting the user ID and password to be displayed, and executes the authentication process for authenticating the user based on the inputted ID and password.

### <Step S10>

In step S10, the control unit 16 determines whether or not the preview end operation has been performed on the operation display unit 10. For example, in a case where the operation key K3 displayed on the display unit 20 is operated, the control unit 16 determines that the preview end operation has been performed. Here, when it is determined that the preview end operation has been performed (S10: YES), the process proceeds to step S11, and when it is determined that the preview end operation has not been performed (S10: NO), the process returns to step S8.

### <Step S11>

In step S11, the control unit 16 closes the preview screen P1 displayed on the operation display unit 10 and returns the process to step S1.

As described above, in the image processing apparatus 1, when the control unit 16 displays the preview screen P1, it is possible to display the preview screen P1 of the limited document in which the contents of the first limited areas and the second limited areas are not recognizable (see FIG. 6). Therefore, it is possible to improve the confidentiality of the document as compared with a case in which the contents of a document with high confidentiality is displayed as is on a preview screen P1.

In addition, on the preview screen P1 (see FIG. 6), the entire target document data D1 is not unrecognizable, but only the limited areas such as the first limited areas and the second limited areas are in a state of being unrecognizable. Therefore, for example, in a case where the target document data D1 read in the scanning process has a fold in the document, is skewed or the like, the user can easily confirm the state on the preview screen P1.

Moreover, when a limited document based on limited display data D2 is displayed on a preview screen P1, a character area such as a page number existing in a non-limited area is in a recognizable state. Therefore, the user is able to grasp a location (page) of a document where a specific abnormality has occurred by referring to the preview screen P1. This is performed, for example, in a case where the scanning process is executed in the image processing apparatus 1 and a specific abnormality occurs while the document data is being read from a plurality of documents. Therefore, the user is able to easily determine the restart location of the scanning process when restarting the scanning process.

In a typical technique, there are situations in which it is not preferable to display the contents of a document on a preview screen. For example, when the content of a highly confidential document is displayed on a preview screen, the confidentiality of the document is impaired.

With the technique according to the present disclosure, an image processing apparatus and an image processing method capable of limiting the content of a document displayed on a preview screen are provided.

What is claimed is:

1. An image processing apparatus, comprising:
a generation processing unit that generates limited display data for displaying a limited document in which content of a limited area satisfying a specific limiting condition is unrecognizable in a document indicated by document data of a processing target in the image processing apparatus; and
a display processing unit that displays a preview screen of the limited document on a display unit of the image processing apparatus based on the limited display data.

2. The image processing apparatus according to claim 1, wherein
the limited display data is data in which the limited area is processed by any of a scrambling process, a mask process, or a mosaic process.

3. The image processing apparatus according to claim 1, wherein
the generation processing unit specifies at least one of a character area including characters and a figure area including figures as the limited area.

4. The image processing apparatus according to claim 1, wherein
the generation processing unit generates the limited display data capable of displaying a plurality of the limited areas in an identifiable manner.

5. The image processing apparatus according to claim 4, wherein
the generation processing unit generates the limited display data capable of displaying character areas that include characters and figure areas that include figures in an identifiable manner.

6. The image processing apparatus according to claim 5, wherein
the generation processing unit specifies the character areas that include characters as the limited areas, and of the character areas, excludes a character area in a preset non-limited area from the limited areas.

7. The image processing apparatus according to claim 1, comprising
an authentication processing unit that authenticates users; wherein
the display processing unit may display the document based on the document data in a case where a user having a specific authority is authenticated by the authentication processing unit.

8. The image processing apparatus according to claim 1, wherein
the document data is data read from the document by an image reading unit.

9. The image processing apparatus according to claim 8, wherein in a case where an abnormality occurs while reading document data by the image reading unit, the generation processing unit generate the limited display data, and the display processing unit displays the limited document.

10. A image processing method comprising:
a generation step of generating limited display data for displaying a limited document in which content of a limited area satisfying a specific limiting condition is recognizable in a document indicated by document data of a processing target in an image processing apparatus; and
a display step of displaying a preview screen of the limited document on the display unit of the image processing apparatus based on the limited display data.
